(19) United States
(12) Patent Application Publication
(10) Pub. No.: US 2012/0107555 A1
(43) Pub. Date: May 3, 2012

(54) Composite Tooling

(76) Inventors: Douglas J. Miller, North Olmsted, OH (US); Robert A Mercuri, Seven Hills, OH (US); Irwin C. Lewis, Oberlin, OH (US); Richard L. Shao, North Royalton, OH (US); Gary Dale Shives, Brunswick, OH (US); Gerald F. Hoffert, Euclid, OH (US); David M. Kaschak, Olmsted Falls, OH (US); John Lichtenberg, Strongsville, OH (US)

(21) Appl. No.: 13/144,722

(22) PCT Filed: Jan. 15, 2010
(86) PCT No.: PCT/US10/21179

§ 371 Date: Dec. 30, 2011

Related U.S. Application Data
(60) Provisional application No. 61/144,785, filed on Jan. 15, 2009.

(51) Int. Cl. B32B 3/00; B29C 33/42; B29C 33/38

(52) U.S. Cl. 428/141; 264/219; 264/139

(57) ABSTRACT

A carbon foam article useful for, inter alia, composite tooling or other high temperature applications, which includes a substrate, wherein the substrate includes at least one material selected from carbon foam, extruded graphite, graphite foam, and isomolded graphite. The tool may also include a skin as a working surface and a filler disposed below the skin. The tool has a surface roughness of no more than about 63 micro-inches. Such a tool may be used to make a composite prototype part.

### BACKGROUND

1. Technical Field

This disclosure relates to materials useful for applications including composite material tooling and others. More particularly, the disclosure relates to a tool which includes carbon foam or other carbon or graphite material, and also includes methods for the production of such materials and methods of making composites from such materials.

2. Background Art

Carbon foams have attracted considerable recent activity because of their properties of low density and low thermal expansion, coupled with either very high or low thermal conductivity. Conventionally, carbon foams are prepared by two general routes. Highly graphitizable foams have been produced by thermal treatment of mesophase pitches under high pressures. These foams tend to have high thermal and electrical conductivities. For example, in Klett, U.S. Pat. No. 6,033,506, a mesophase pitch is heated while subjected to a pressure of 1000 psi to produce an open-cell foam containing interconnecting cells with a cell size range of 90-200 microns. According to Klett, after heat treatment to 2800° C., the solid portion of the foam develops into a highly crystalline graphitic structure with an interlayer spacing of 0.366 nm. The foam is asserted to have compressive strengths greater than previous foams (3.4 MPa or 500 psi for a density of 0.53 g/cc).

In Hardcastle et al. (U.S. Pat. No. 6,776,936) carbon foams with densities ranging from 0.678-1.5 g/cc are produced by heating a pitch in a mold at pressures up to 800 psi. The foam is alleged to be highly graphitizable and provide high thermal conductivity (250 W/m-K).

According to H. J. Anderson et al. in Proceedings of the 43^{rd} International SAMPE Meeting, p756 (1998), carbon foam is produced from a mesophase pitch followed by oxidative thermosetting and carbonization to 900° C. The foam has an open cell structure with interconnecting pores, having varying cell shapes and diameters ranging from 39 to greater than 480 microns.

Rogers et al., in Proceedings of the 45^{th} SAMPE Conference, pg 293 (2000), describe the preparation of carbon foams from coal-based precursors by heat treatment under high pressures to give materials with densities of 0.35-0.45 g/cc with compressive strengths of 2000-3000 psi (thus a strength/density ratio of about 6000 psi/g/cc). These foams have an open-celled structure of interconnected pores with cell sizes ranging up to 1000 microns. Unlike the mesophase pitch-derived foams described above, they are not highly graphitizable. In a recent publication, the properties of this type of foam were described (High Performance Composites September 2004, pg.25). The foam has a compressive strength of 800 psi at a density of 0.27 g/cc or a strength to density ratio of 3000 psi/g/cc.

Stiller et al. (U.S. Pat. No. 5,888,469) describe production of carbon foam by pressure heat treatment of a hydrotreated coal extract. These materials are claimed to have compressive strengths of 600 psi for densities of 0.2-0.4 g/cc (strength/density ratio of from 1500-3000 psi/g/cc). It is suggested that these foams are stronger than those having a glassy carbon or vitreous nature which are not graphitizable.

Carbon foams can also be produced by direct carbonization of polymers or polymer precursor blends. Mitchell, in U.S. Pat. No. 3,302,999, discusses preparing carbon foams by heating a polyurethane polymer foam at 200-255° C. in air followed by carbonization in an inert atmosphere at 900° C. These foams have densities of 0.085-0.387 g/cc and compressive strengths of 130 to 2040 psi (ratio of strength/density of 1529-5271 psi/g/cc).

In U.S. Pat. No. 5,945,084, Droege described the preparation of open-celled carbon foams by heat treating organic gels derived from hydroxylated benzenes and aldehydes (phenolic resin precursors). The foams have densities of 0.3-0.9 g/cc and are composed of small mesopores with a size range of 2 to 50 nm.

Mercuri et al. (Proceedings of the 9^{th} Carbon Conference, p.206 (1969) prepared carbon foams by pyrolysis of phenolic resins. For foams with a density range of 0.1-0.4 g/cc, the compressive strength to density ratios were from 2380 to 6611 psi/g/cc. The cells were ellipsoidal in shape with cell diameters of 25-75 microns) for a carbon foam with a density of 0.25 g/cc.

Stankiewicz (U.S. Pat. No. 6,103,149) prepares carbon foams with a controlled aspect ratio of 0.6-1.2. The patentee points out that users often require a completely isotropic foam for superior properties with an aspect ratio of 1.0 being ideal. An open-celled carbon foam is produced by impregnation of a polyurethane foam with a carbonizable resin followed by thermal curing and carbonization. The cell aspect ratio of the original polyurethane foam is thus changed from 1.3-1.4 to 0.6-1.2.

Unfortunately, some carbon foams produced by the prior art processes are not effective for many high temperature applications such as composite tooling. The foams generally available are not monolithic and do not have the strength and strength-to-density requirements for such application. In addition, open-celled foams with highly interconnected cells have porosities making them ill-placed for such applications.

In U.S. Published Patent Application No. US2006/086043, Douglas J. Miller, Irwin C. Lewis and Robert A. Mercuri disclose a carbon foam which overcomes the noted deficiencies in foams produced by prior art processes. More specifically, the Miller et al. foam has a bimodal cell structure, with a combination of larger and smaller relatively spherical cells, which provide a carbon foam which can be produced in a desired size and configuration and which can be readily machined, providing a carbon foam which exhibits a density, compressive strength and compressive strength to density ratio to provide a combination of strength and relatively light weight characteristics not heretofore seen. This bimodal cell distribution provides a combination of two average cell sizes, with the primary fraction being the larger size cells and a minor fraction of smaller size cells.

### BRIEF DESCRIPTION

Disclosed herein is a tool which includes a substrate and a skin, wherein the substrate comprises at least one material selected from carbon foam, extruded graphite, graphite foam, and isomolded graphite. The skin may form a working surface of the tool. The tool may further include a filler substantially filling the open cells along a top surface of the substrate. Advantageously, the surface roughness of the working surface comprises no more than about 63 micro-inches. Preferably, the tool has a vacuum integrity of less than about 0.5 in-Hg of loss over a time period of at least about 5 minutes, and the combination of the filler and the skin extends no more than about 525 micrometers from the top surface of the substrate. Further disclosed here in is a method of making such a tool.

Also disclosed herein is a method of making a composite prototype part. The method includes applying a prepreg for making the prototype part to the above tool. The tool includes the substrate, and the filler-skin combination which extends no more than about 525 micrometers from a top surface of the substrate and the tool has a working surface with a surface roughness of no more than about 63 micro-inches.

It is to be understood that both the foregoing general description and the following detailed description provide embodiments of the invention and are intended to provide an overview or framework of understanding and nature and character of the invention as it is claimed. The accompanying drawing is included to provide a further understanding of the invention and is incorporated in and constitutes a part of the specification. The drawing illustrates various embodiments of the invention and together with the description serves to describe the principles and operations of the invention.

### BRIEF DESCRIPTION OF THE DRAWINGS

FIG. 1 is a schematic view of an embodiment of a tool disclosed herein.

### DETAILED DESCRIPTION OF THE PREFERRED EMBODIMENTS

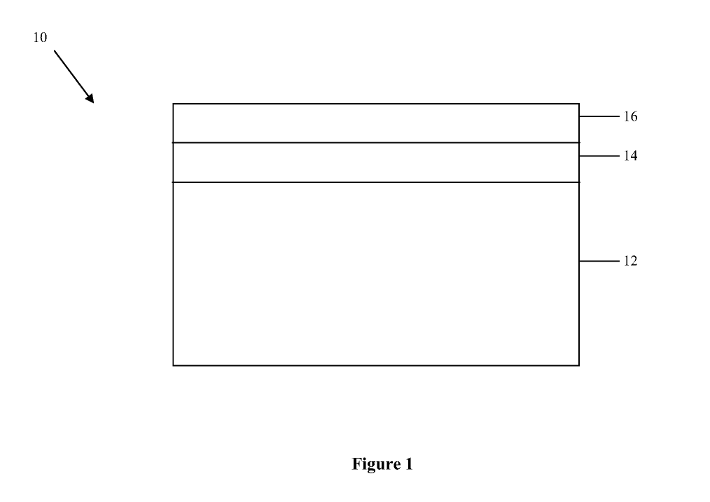

Illustrated in FIG. 1 is a cross sectional view of an embodiment of a composite article 10 useful as a tool for a composite tooling application. Article 10 includes a substrate 12. The substrate may comprise at least one material selected from carbon foam, extruded graphite, graphite foam, and isomolded graphite. The carbon foam from which substrate 12 is formed can be made from any type of precursor material such as, but not limited to, coal, pitch, isotropic pitch, mesophase pitch and/or polymeric foam. In one embodiment, substrate 12 may be made from more than one piece of carbon foam. In such an embodiment the pieces of carbon foam may be joined together by the use of a carbonaceous cement. In another embodiment, the pieces of foam may be joined together by the use of a film, an adhesive or by an elastomeric sheet between the adjacent pieces of foam. Preferably the material used to bond the foam will withstand the highest processing temperature of the either or both of the process of making the tool and/or using the tool. Examples of suitable temperatures for such an adhesive include up to more than about 540° C. In one particular embodiment, the temperature stability of the adhesive is up to about 300° C., in another embodiment up to about 250° C. Some examples of suitable materials for bonding blocks of carbon foam include Pelseal® 3159 (a fluoro-elastomer available from Pelseal Technologies LLC), Hysol® EA 9394/C-2 (a thermosetting plastic available from Dexter Corp.), Fluorolast WB® 200 (a polymeric coating available from Laurnell International Inc.), X-Pando® (available from X-Pando Corp.), BMI film adhesives (available from Cytec or Hexcel), and C34™ cement (available from GrafTech International Holdings Inc.). In another embodiment, substrate 12 is formed of a monolithic block of carbon foam.

As noted, the carbon foam may be formed from other materials such as pitch, coal, mesophase pitch, isotropic pitch, and/or other carbonizable materials which may be foamed. In a preferred embodiment, however, the carbon foam used to form carbon foam substrate 12 is prepared from polymeric foams, such as polyurethane foams or phenolic foams, with phenolic foams being preferred. Phenolic resins are a large family of polymers and oligomers, composed of a wide variety of structures based on the reaction products of phenols with formaldehyde. Phenolic resins are prepared by the reaction of phenol or substituted phenol with an aldehyde, especially formaldehyde, in the presence of an acidic or basic catalyst. Phenolic resin foam is a cured system composed of open and closed cells. The resins are generally aqueous resoles catalyzed by sodium hydroxide at a formaldehyde: phenol ratio which can vary, but is preferably about 2:1. Free phenol and formaldehyde contents should be low, although urea may be used as a formaldehyde scavenger.

The foam is prepared by adjusting the water content of the resin and adding a surfactant (e.g., an ethoxylated nonionic), a blowing agent (e.g., pentane, methylene chloride, or chlorofluorocarbon), and a catalyst (e.g., toluenesulfonic acid or phenolsulfonic acid). The sulfonic acid catalyzes the reaction, while the exotherm causes the blowing agent, emulsified in the resin, to evaporate and expand the foam. The surfactant controls the cell size as well as the ratio of open-to-closed cell units. Both batch and continuous processes are employed. In the continuous process, the machinery is similar to that used for continuous polyurethane foam. The properties of the foam depend mainly on density and the cell structure.

The preferred phenol is resorcinol, however, other phenols of the kind which are able to form condensation products with aldehydes can also be used. Such phenols include monohydric and polyhydric phenols, pyrocatechol, hydroquinone, alkyl substituted phenols, such as cresols or xylenols; polynuclear monohydric or polyhydric phenols, such as naphthols, p.p′-dihydrexydiphenyl dimethyl methane or hydroxyanthracenes.

The phenols used to make the foam starting material can also be used in admixture with non-phenolic compounds which are able to react with aldehydes in the same way as phenol.

The preferred aldehyde for use in the solution is formaldehyde. Other suitable aldehydes include those which will react with phenols in the same manner. These include, for example, acetaldehyde and benzaldehyde.

In general, the phenols and aldehydes which can be used in the process of the invention are those described in U.S. Pat. Nos. 3,960,761 and 5,047,225, the disclosures of which are incorporated herein in reference in their entirety.

The polymeric foam used as the starting material in the production of the inventive carbon foam should have an initial density which mirrors the desired final density for the carbon foam which is to be formed. In other words, the polymeric foam should have a density of about 0.01 to about 0.6 g/cc, more preferably about 0.01 to about 0.5 g/cc. In terms of a carbon foam for use as carbon foam substrate 12, a preferable density is less than about 1.0 g/cc; preferably less than about 0.6 g/cc. In a further embodiment, preferably, foam used to form substrate 12 has a density of at least about 0.03 g/cc. The cell structure of the polymeric foam should have a porosity of between about 65% and about 95% and a relatively high compressive strength, i.e., on the order of at least about 100 psi, and as high as about 300 psi or higher.

Advantageously, the carbon foam has a relatively uniform distribution of cells. Also, it is preferred that the cells are relatively isotropic, by which is meant that the cells are relatively spherical, meaning that the cells have, on average, an aspect ratio of between about 1.0 (which represents a perfect spherical geometry) and about 1.5. The aspect ratio is determined by dividing the longest dimension of any cell with its shortest dimension.

As noted, the carbon foam may have a total porosity of about 65% to about 95%, more preferably about 70% to about 95%. In addition, it has been found highly advantageous for the foam to have a bimodal cell distribution, that is, a combination of two average cell sizes, with the primary fraction being the larger size cells and a minor fraction of smaller size cells. Preferably, of the cells, at least about 90% of the cell volume, more preferably at least about 95% of the cell volume should be the larger size fraction, and at least about 1% of the cell volume, more preferably from about 2% to about 10% of the cell volume, should be the smaller size fraction.

The larger cell fraction of the bimodal cell distribution in the carbon foam should comprise cells from about 10 to about 150 microns in diameter, more preferably about 15 to about 95 microns in diameter, most preferably about 25 to about 95 microns in diameter. The smaller fraction of cells should comprise cells that have a diameter of about 0.8 to about 3.5 microns, more preferably about 1 to about 2 microns. The bimodal nature of the cell distribution in the foam used to form carbon foam substrate 12 provides an intermediate structure between open-celled foams and closed-cell foams, thus limiting the liquid permeability of the foam while maintaining a foam structure. Indeed, advantageously, the carbon foam should exhibit a nitrogen permeability of no greater than about 3.0 darcys, more preferably no greater than about 2.0 darcys (as measured by ASTM C577).

Typically, characteristics such as porosity and individual cell size and shape are measured optically, such as by use of an epoxy microscopy mount using bright field illumination, and are determined using commercially available software, such as Image-Pro Software available from MediaCybernetic of Silver Springs, Md.

In order to convert the polymeric foam to carbon foam, the polymeric foam is carbonized by heating to a temperature of from about 500° C., more preferably at least about 800° C., up to about 3200° C., in an inert or air-excluded atmosphere, such as in the presence of nitrogen. The heating rate should be controlled such that the polymer foam is brought to the desired temperature over a period of several days, since the polymeric foam can shrink by as much as about 50% or more in volume during carbonization. Preferably, the polymeric foam is substantially uniformly heated.

By use of a polymeric foam heated in an inert or air-excluded environment, a non-graphitizing glassy carbon foam is obtained, which has the approximate density of the starting polymer foam, but a compressive strength of at least about 2000 psi and, significantly, a ratio of strength to density of at least about 7000 psi/(g/cc), more preferably at least about 8000 psi/(g/cc). The carbon foam has a relatively uniform distribution of isotropic cells in a bimodal cell size distribution as described hereinabove, the cells having, on average, an aspect ratio of between about 1.0 and about 1.5. If so desired, the carbon foam may be heated to typical graphitization temperatures.

In the case of substrate 12 including graphite foam, the foam may be conductive foam In one embodiment, the foam may have density which ranges from about 0.15 g/cc to greater than about 0.45 g/cc. In a particular embodiment, graphite foam of substrate 12 has a substantially uniform density in the rise direction, more preferably in the rise direction as well as the horizontal directions. The bulk thermal conductivity of the graphite foam may be at least about 20 W/mK, preferably at least about 40 W/mK, more preferably at least about 100 W/mK, and even more preferably at least about 150 W/mK. In one embodiment, the thermal conductivity is up to about 180 W/mK.

Preferably the graphite foam has a compressive strength of at least about 15 psi, more preferably at least about 50 psi, even more preferably at least about 100 psi, and most preferably at least about 150 psi. In one particular embodiment, the compressive is up to about 200 psi. In further embodiments, the graphite foam may include pores in the pore structure having a pore size of at least about 100 microns up to about 500 microns. Additionally, such foam may include a pore concentration of about 20 pores per inch; up to about 100 pores per inch.

In addition or instead of carbon foam and/or graphite foam, substrate 12 may include either or both of extruded graphite and isomolded graphite. Non-limiting examples of extruded graphite include CS™, CSX™, and CBY™ types of graphite available from GrafTech International Holdings Inc. of Parma, Ohio and non-limiting examples isomolded graphite includes ATJ™, ATA™, and ATR™, all of which are also available from GrafTech International Holdings Inc. of Parma, Ohio. The afore material which may be used to form substrate 12 may be used in any combination thereof.

Referring again to FIG. 1, a filler material 14 is positioned on a top surface of carbon foam substrate 12. In one embodiment disclosed herein, material 14 does not extend above the top surface by a distance of more than about 25 μm, preferable no more than 15 μm, more preferably no more than about 10 μm. In one particular embodiment, filler 14 only nominally extends above the top surface of substrate 12. Article 10, when used as a tool, further includes a skin material 16 on an outer surface, preferably forming a working surface of tool 10.

Some advantageous materials for use as filler 14 may provide some or all of the following benefits: (1) filler 14 once applied to a top surface of the substrate may reduce the surface roughness of the top surface of the substrate-filler combination to less than the surface roughness of the substrate alone, preferably reducing the roughness by at least about ⅓, more preferably at least about ½; (2) the material may have a sufficient viscosity so that it can be easily dispersed along a top surface of substrate 12 and that the material sufficiently fills any cells, voids, depressions, or other irregularities on such surface of substrate 12 whereby the combination of substrate 12 and filler 14 has top surface which is substantially void free and substantially smooth; (3) the material may include particles; and/or (4) sufficiently fills the cells, depressions and/or voids of substrate 12 so that when skin 14 is added, tool 10 may have a working surface with a desired smoothness and vacuum integrity. Filler 14 may or may not provide sufficient vacuum integrity.

Preferable sizes of particles include the appropriate sizes to fill any cells, depressions, etc. open to a top surface of substrate 12. Some examples of suitable particle sizes include less than about 150 microns, less than about 100 microns, less than about 50 microns, less than about 25 microns, and less than about 10 microns. Examples of suitable materials for the particles include carbonaceous materials, such as carbon and/or graphite powders, clay, talc, calcium carbonate, quartz, and combinations thereof.

Preferably, filler 14 is a material which may expand upon the thermal cycling during the process of making a part and/or of making tool 10, however, it is further preferred that the filler 14 in expanding does not expand with sufficient force to stress the internal structure of substrate 12. Some examples of materials which may be used as filler 14 include an acrylic based material, a gypsum based material, a nitrocellulose based material, and combinations thereof.

In one embodiment filler 14 is dispersed onto substrate 12 by mechanical techniques such a spreading, scraping, etc.

Returning to the surface roughness, in one certain embodiment the application of filler 14 to the top surface of substrate 12 reduces the roughness of the top surface from about 400 μ-inches or more to equal to or less than about 200 μ-inches.

Optionally the top surface of the substrate 12-filler 14 combination may be sanded, preferably lightly sanded after filler 14 cures. Such sanding may be done to the extent to remove any isolated build-up of filler 14 observable to by the naked eye.

With respect to skin 16, preferably skin 16 is located on a top surface of the assembly of the substrate 12 and filler 14. It is preferred that skin 16 has a thickness of no more than about 500 μm, preferably no more than about 400 μm, and even more preferred no more than about 250 μm. Preferably skin 16 is of a sufficient viscosity that it can be applied in a substantially liquid form, by rolling, brushing, squeegeeing, spraying operations or the like. In one particular embodiment, skin 16 is stable at temperatures greater than about 250° F. It is also preferred that skin 16 has a sufficient amount of elasticity for thermal cycling such that the skin will not delaminate from the rest of tool 10 during thermal cycling of at least about 350° F., preferably at least about 375° F. It is also preferred that the skin material will maintain vacuum integrity. It is further preferred that skin 16 can withstand autoclave curing at temperatures of at least about 350° F. at pressures of about 100 psi, further temperatures of at least about 375° F. An example of a material that may be useful as skin 16 is an epoxy-acrylic material. In a further example filler 14 may be a different material from skin 16.

In one particular embodiment, both filler 14 and skin 16 each have a coefficient of thermal expansion (“CTE”) which is less than about 20 times greater than the CTE of substrate 12, preferably, no more than about 15 times greater, and even more preferably no more than about 10 times greater.

Preferably tool 10, having filler 14 and skin 16, has a top surface, such surface also known as a working surface, wherein at least a majority of the surface has a surface roughness of no more than about 63 μ-in, preferably no more than about 50 μ-in, more preferred no more than about 40 μ-in, and even more preferred no more than about 30 μ-in. Preferably for any one of the above embodiments, at least about seventy-five (75%) of the surface has the aforementioned surface roughness, more preferably at least about ninety (90%), and even more preferably substantially all, and, most preferably, all of the working surface has the aforementioned surface roughness. A Phase II TR100 Surface Roughness Tester (“Tester”) may be used to determine the surface roughness. In one particular embodiment, the surface roughness is determined by using the Tester on more than one location of the top surface of skin 16. In one embodiment, the Tester may use a root-mean square (“RMS”) algorithm to calculate the surface roughness. However, any suitable algorithm maybe used to calculate the surface roughness. A non-limiting example of another such algorithm is an arithmetic mean. Optionally, if desired, the tool surface may be wet sanded to reduce surface roughness. It is further preferred that during formation of tool 10 as well as during use of tool 10, that skin 16 does not develop microcracks or other defects which would inhibit vacuum integrity.

If so desired, skin 16 on the top surface of tool 10 may be dry or wet sanded for various reasons, such as to adjust the surface roughness, remove pockets of agglomeration of material, etc.

Regarding vacuum integrity, it is preferred that tool 10 will maintain vacuum integrity to the extent to have no more than about 0.5 in-Hg of loss over a time period of at least about five (5) minutes, preferably at least about twenty (20) minutes, and more preferably at least about thirty (30) minutes. In a further embodiment, the loss is no more than about 0.2 in-Hg for the above given time periods, preferably no more than about 0.1 in-Hg.

One method of forming article 10 includes applying filler material 14 to carbon foam substrate 12 and then curing filler 14.

Next, skin material 16 is applied to a top surface of the combination of substrate 12 and filler material 14.

Machining of tool 10 may also take place. Tool 10 may be machined in any desired manner. In one such manner, the desired tool image is machined into the skin. Alternatively, substrate 12 may be machined and the desired outer materials (filler material 14 and/or skin material 16) may be applied to the machined surface of substrate 12. In a further alternative, the top surface of substrate 12 filler material 14 combination may be a surface that is machined. Additionally, more than one part of tool 10 may be machined. For example, but not limited to, a rough image of the desired shape may be machined into a surface of substrate 12. then a final image of the desired shape may be machined into a top surface of the combination of substrate 12-filler 14 Preferably the machining takes place in at least the one direction of the top surface, more preferably at least two directions (e.g., x and y directions, and in some instances in all three (3) directions, (e.g., x, y, and z directions). Preferably, machining takes place in an enclosed environment. Two examples of machining tools include carbide and diamond coated machining tools.

Tool 10 may be used to make a prototype composite part. In one instance a prepreg material is applied to a working surface of tool 10. The prepreg is not limited to any particular prepreg. Two examples of suitable classes of prepreg that may be used include prepregs which include low temperature cure materials (e.g., cured at temperatures of about 200° C. or below, preferably about 40° C. to 200° C.) and prepregs which include high temperature cure materials (e.g., cure above temperatures of more than 200° C.). Examples of materials which may be used as a prepreg to make the part are provided in WO 2005/070462 which is incorporated herein by reference in its entirety. Other materials than prepregs which may be used to make a part include resins and vinyl esters, which are also disclosed in the above publication incorporated herein in its entirety.

The prepreg (from herein the discussion regarding the prepreg is also applicable to resins and vinyl esters) may be laid up on the working surface and subjected to conditions suitable to mold the prepreg to a desired shape, thereby fabricating a composite part from the prepreg. In an embodiment, molding is facilitated by subjecting the laid-up prepreg to non-atmospheric pressure and/or temperature, such as vacuum conditions. A part may be made form tool 10 by the use of by various techniques, two of such techniques being resin transfer molding and vacuum assisted resin transfer molding. Examples of conditions which may be used to make the part include heating tool 10 having a prepreg to a temperature of about to about 600° C. or less, preferably about 400° C. or less and/or subjecting the prepreg while disposed on tool 10 to a vacuum of more than 0 about to about 30 in Hg. For further explanation regarding resin transfer molding U.S. Pat. No. 5,152,949 is incorporated herein by reference in its entirety.

In a further embodiment, the prepreg may be vacuum bagged while it is on tool 10. Vacuum bagging may include bagging the prepreg directly against the working surface, or alternatively, vacuum bagging the prepreg along with tool 10. In an embodiment, the prepreg is vacuum bagged by a vacuum membrane being located around the prepreg and the membrane being attached to the sides of tool 10, thereby forming an enclosure in which the prepreg is encased. In a particular embodiment, the bag is a thin film, the bag may be made of various types of materials such as nylon, reinforced silicone rubber, or unreinforced silicone rubber.

Additionally, the prepreg may be cured on tool 10. In one embodiment, an oven may be used to cure the prepreg alternatively, the prepreg may be cured under substantially autoclave pressure. Also, during cure of the prepreg, air may be withdrawn from the enclosure. Preferably a suitable amount of air is withdrawn to consolidate and reduce the formation of voids within the prepreg being cured. Furthermore, the composite part is removed from tool 10. The method may further include making additional composite parts from tool 10, typically no more than about 10 parts, and more typically no more than about 5 parts. Minimally tool 10 should survive making at least one part.

Tool 10 has many advantages over other types of tools used for prototype tooling. One such advantages is that tool 10 may be used at higher cure temperatures than other similarly situated tools. Also, tool 10 has the advantage of being able to be made very quickly which provides the maker of tool 10 the opportunity to have a short lead time for tool 10.

The above various embodiments, may be practiced individually or in any combination thereof.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A composite tool comprising a substrate and a skin, wherein the skin forms a working surface of the tool, further including a filler substantially filling a plurality of open cells along a top surface of the substrate, wherein a surface roughness of at least a majority of the working surface comprises no more than about 63 micro-inches, the tool has a vacuum integrity of less than about 0.5 in-Hg of loss over a time period of at least about 5 minutes, and the combination of the filler and the skin extends no more than about 525 micrometers from the top surface of the substrate, wherein the substrate comprises at least one selected from carbon foam, extruded graphite, graphite foam, and isomolded graphite.

2. The tool of claim 1 wherein the filler has a temperature stability of at least about 350° F.

3. The tool of claim 1 wherein the filler includes particles of less than about 150 microns.

4. The tool of claim 1 wherein the skin has a temperature stability of greater than about 250° F.

5. The tool of claim 1 wherein each one of the filler and the skin have a CTE of no more than about 20 times the CTE of the substrate.

6. The tool of claim 1 wherein the filler includes carbonaceous material.

7. The tool of claim 1 wherein the skin comprises an epoxy-acrylic material.

8. A method of making a composite prototype part comprising applying a prepreg to a tool, the tool having a substrate and a filler-skin combination which extends no more than about 525 micrometers from a top surface of the foam and the tool having a working surface wherein a surface roughness of a at least a majority of the surface comprises no more than about 63 micro-inches, the substrate comprises at least one selected from carbon foam, extruded graphite, graphite foam, and isomolded graphite.

9. The method of claim 8 further comprising fabricating the composite part from the tool.

10. The method of claim 8 comprising laying up the prepreg on a working surface of the tool.

11. The method of claim 8 comprising vacuum bagging at least the prepreg.

12. The claim 8 comprising curing the prepreg.

13. The claim 12 comprising removing the cured composite part from the tool.

14. The claim 8 comprising using the tool to fabricate additional composite parts.

15. A method of making a prototype tool comprising
a) machining a porous top surface of a substrate to a desired contour, wherein the substrate comprises at least one selected from carbon foam, extruded graphite, graphite foam, and isomolded graphite;
b) applying a filler material including particles, wherein at least a majority of the particles have a size of less than 150 microns to a the top surface of the substrate thereby forming a composite of the substrate and the filler having a substantially void-free top surface; and
c) applying a skin to the top surface of the composite thereby forming a working surface of the tool.

16. The method of claim 15 further comprising sanding the top surface of the tool.

17. The method of claim 15 wherein the machining of the substrate includes machining the substrate in at least two directions.

18. A method of making a tool useful for producing a composite part, comprising
a) machining a surface of a substrate to a desired contour, the substrate having a porosity of at least 65%, wherein the substrate comprises at least one selected from carbon foam, extruded graphite, graphite foam, and isomolded graphite;
b) coating the machined surface of the substrate with a filler material, the filler material sufficiently filling the pores of the machined surface to thereby a composite having a substantially smooth top surface; and
c) coating the top surface of the composite with a skin material, the skin material different from the filler material and thereby forming a working surface,
whereby a roughness of at least a majority of the working surface comprises no more than about 63 micro-inches and a vacuum integrity of the tool comprises less than about 0.5 in-Hg of loss over a time period of at least about 5 minutes.

19. A method of making a composite part comprising the method of claim 18 and further comprising laying up a prepreg on the working surface of the tool, curing the prepreg thereby forming the part, and removing the part from the tool.
